(19) United States
(12) Patent Application Publication
(10) Pub. No.: US 2005/0098527 A1
(43) Pub. Date: May 12, 2005

(54) Multiple cavity bottle and method of manufacturing same

(76) Inventor: William M. Yates III, Foothill Ranch, CA (US)

Correspondence Address: FELIX L. FISCHER, ATTORNEY AT LAW, 1607 MISSION DRIVE, SUITE 204, SOLVANG, CA, 93463, US

(21) Appl. No.: 10/942,332

(22) Filed: Sep. 15, 2004

Related U.S. Application Data
(60) Provisional application No. 60/502,892, filed on Sep. 15, 2003.
(60) Provisional application No. 60/551,165, filed on Mar. 8, 2004.

(51) Int. Cl. B65D 1/04; B29C 49/12

(52) U.S. Cl. 215/6; 264/532

(57) ABSTRACT

A multiple cavity bottle is provided with a joining inner wall providing two sealed cavities for containing differing commodities. Shaping of the inner wall allows viewing of both commodities. Forming the bottle from two substantially symmetrical elements contacting at the inner wall allows use of a common mold for both bottle elements.

### RELATED APPLICATIONS

This application claims priority of U.S. provisional application Ser. No. 60/502,892 filed Sep. 15, 2003 entitled “BOTTLE HAVING MULTIPLE CAVITIES” and U.S. provisional application Ser. No. 60/551,165 filed Mar. 8, 2004 and having the same title as the present application, the disclosures of which are fully incorporated herein by reference. This application is co-pending with U.S. Design patent application Ser. No. 29/202,579 filed on Apr. 1, 2004 entitled DUAL CAVITY BOTTLE and having a common inventor with the present application, the disclosure of which is fully incorporated herein by reference.

### BACKGROUND

1. Field of the Invention

This invention generally relates to liquids containers, and more specifically to a bottle having multiple separated cavities for containing different commodities.

2. Description of the Related Art

Liquid storage containers have been provided in numerous sizes and shapes for various liquid commodities. The most ubiquitous containers are presently plastic and provide multiple sizes and shapes with mass production capability and recyclable materials.

In many endeavors, individuals use multiple commodities in combination. Sports enthusiasts are typically becoming aware of the benefits of combining the use of electrolyte replacing sports drinks with water for ultimate performance enhancement and refreshment. Children often desire to purchase more than a single flavor of soft drink or juices or combine a soft drink or juice with other liquid refreshment such as water or milk.

Beverage companies frequently launch new product flavors and have the need to inform customers that the new flavors are associated with their existing well-known brand and comprise part of their product portfolio. Currently, these companies are limited to arranging single-cavity bottles containing the new flavors in close proximity to other single-cavity bottles containing the well-known brand at the point of purchase.

Connected bottles for containing common use or multipart commodities such as shampoo and conditioner, glue and hardener and similar products have been available. However, such connected bottles do not provide an integrated, visually pleasing container which minimizes manufacturing complexity.

It is therefore desirable to provide a single container having multiple cavities for storage of different commodities. It is further desirable that such a container be easily manufactured.

### SUMMARY OF THE INVENTION

A multiple cavity bottle is created using a first element with a first cavity having a mating surface and an outer surface and a second element with a second cavity having a mating surface and an outer surface. The mating surface of the second element is complimentary in shape to the mating surface of the first element and the second element engages the first element with intimate contact of the mating surfaces. In exemplary embodiments, the elements are geometrically identical and the mating surface of each element is helical with a planar cross section. Interconnection of the first and second elements is accomplished in certain embodiments using complimentary male and female features on the mating surface. Combination of symmetrically located male and female features allows the elements to retain their identical configurations for manufacturing simplicity.

A multiple cavity bottle employing the present invention is fabricated using injection molding to create a preform followed by blow molding of the bottle or bottle elements. In a first embodiment, a mold is provided with at least one substantially helical inner surface. The preform has one flat surface and the preform is engaged in the mold with the flat surface aligned with an initiation of the helical inner surface. An expandable portion of the preform is reheated and a helically shaped stretch rod is inserted into the preform with partial pressurization to spirally stretch the preform. The preform is then fully pressurized into the mold to create a bottle element. The bottle element is then assembled with a second bottle element to create a dual cavity bottle.

In an alternative embodiment, the multiple cavity bottle is fabricated having two substantially half cylindrical cavities separated by a septum. The preform is expanded into a stretch blow mold to form the product bottle. In certain embodiments, the mold is provided with a fixed portion engaging a neck of the preform and a rotatable portion receiving a base of the expanded bottle. A product bottle with both cavities viewable from any direction is then obtained by rotating the rotatable portion of the mold immediately after expansion while still hot to helically shape the mating septum.

### BRIEF DESCRIPTION OF THE DRAWINGS

These and other features and advantages of the present invention will be better understood by reference to the following detailed description when considered in connection with the accompanying drawings wherein:

FIG. 1 is an isometric view of a first embodiment of a bottle incorporating the present invention;

FIG. 2a is a top view of a first element of the embodiment shown in FIG. 1;

FIG. 2b is a side view of the element of FIG. 2a;

FIG. 2c is a bottom view of the element of FIG. 2a;

FIG. 3a is a top view of a first element of the embodiment shown in FIG. 1;

FIG. 3b is a side view of the element of FIG. 3a;

FIG. 3c is a bottom view of the element of FIG. 3a;

FIG. 4 is an isometric exploded view of the first embodiment showing the interconnecting fit of the first and second elements;

FIG. 5a is a top view of the embodiment of FIG. 1;

FIG. 5b is a bottom view of the embodiment of FIG. 1 showing an indexing feature;

FIG. 5c is a bottom view of an embodiment of the invention showing an engagement configuration for the bottle elements;

FIG. 6a is a side view of a second embodiment of the invention;

FIG. 6b is a top view of the second embodiment shown in FIG. 6a;

FIG. 7a is a side view of an embodiment of the invention showing a bottom engagement feature;

FIG. 7b is a partial section view of the embodiment of FIG. 7a showing additional detail of the bottom engagement feature.

FIG. 7c is a bottom view of the embodiment of FIG. 7a;

FIG. 8a is a side view of an embodiment of the invention showing a top engagement feature;

FIG. 8b is a top view of the embodiment of FIG. 8a;

FIG. 8c is a top view of a modification to the embodiment of FIG. 8a;

FIG. 8d is a partial side view of an alternative embodiment of the invention showing an alternative top engagement features and a sealing cap arrangement;

FIG. 9 is a side view of a double ended embodiment of the invention with a self-standing cap feature;

FIG. 10a is a top view of the self-standing cap;

FIG. 10b is a top view of an alternative embodiment of the self-standing cap;

FIG. 10c is a bottom view of the cap of FIG. 10b;

FIG. 11 is a side section view of an alternative embodiment of the double ended bottle configuration;

FIG. 12 is a side view with partial section of attachment elements for a second alternative embodiment of the double ended bottle configuration;

FIG. 13a is a side view of a prior art blow molding preform and resulting expanded bottle shown in phantom;

FIG. 13b is a side view of a blow molding preform and resulting expanded bottle shown in phantom for the present invention;

FIG. 13c is a detailed top view of the preform;

FIG. 13d is a detailed side view of the preform;

FIG. 13e is a side section view of a mold for expanding the preform;

FIG. 14a is a top view of a bottle incorporating the invention as manufactured from the preform of FIG. 13c; and,

FIG. 14b is a side view of the bottle of FIG. 14a.

### DETAILED DESCRIPTION OF THE INVENTION

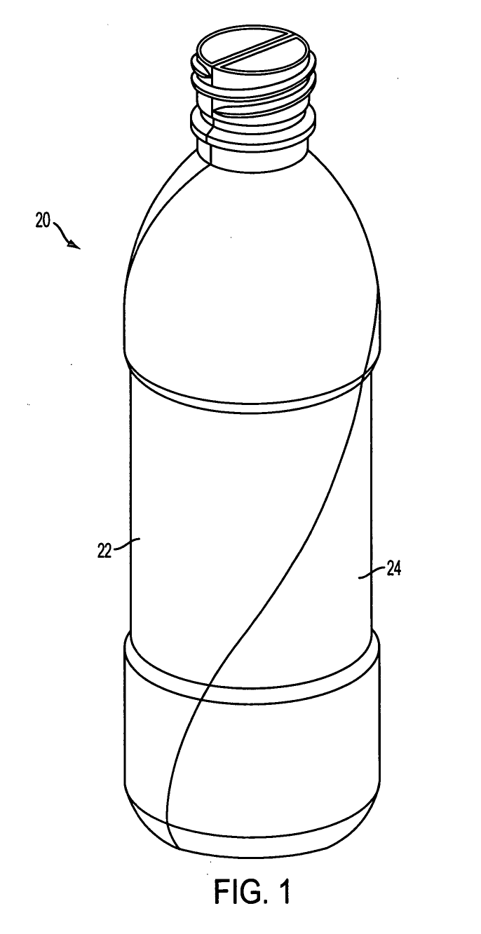

Referring to the drawings, FIG. 1 is an isometric view of a bottle 20 incorporating the elements of the invention. For the embodiment shown, elements or moieties of a combination forming the invention are a first bottle half 22, and second bottle half 24 that are engaged to form the completed bottle having two separate cavities for storage and dispensing of two separate liquids.

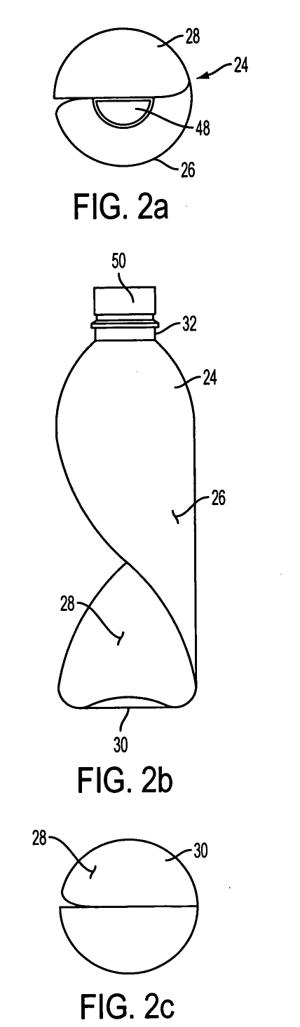

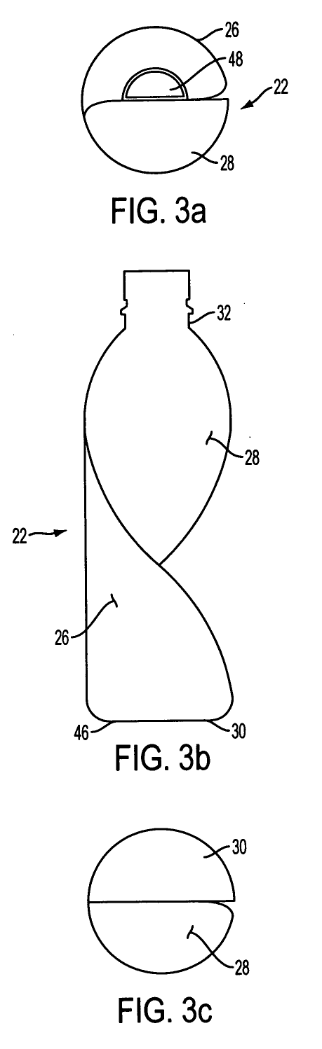

Bottle halves 22 and 24, are shown with more particularity in FIGS. 2a-2c and 3a-3c. The views provided show an identical configuration of the bottle halves but are shown separately to demonstrate the orientation of the halves for mating as the bottle. Each half has an outer surface 26 and mating surface 28. The outer surface 26 of the first bottle half 22, and second bottle half 24 may be of any shape, but for the example shown have a generally cylindrical outer surface 26. The mating surfaces 28 of each bottle half are formed as complimentary shapes, allowing the bottle halves to adjacently seat together in a side-by-side relationship.

In the embodiment shown, the mating surface 28 of each bottle half forms a generally flat plane with a helical twist or, alternatively described, the helical mating surface has a planar cross section. The flat shape is preferred because it allows both bottle halves to be manufactured as the same part. Alternately, the mating surface 28 may be shapes other than flat, such as concave and convex and may have male and female joining features, but any such features or shapes that are not symmetrical require that the bottle halves are formed as two separate parts from different molds. The amount of twist from the top portion 32 of the bottle to the bottom portion 30 of the bottle can be any number of degrees and the preferred embodiment is between 45° and 360° with a 180° twist shown in the drawings. When the bottle halves 22 and 24 are seated together, their mating surfaces 28 sit adjacently together along the flat twisted plane that is formed at the angle of helical rotation. This helical shaping, particularly if 180° of twist or greater, allows the contents of the two cavities of the combined bottle to be viewed from any aspect thereby enhancing the marketability of the products contained in the bottle by clearly demonstrating the presence to two distinct commodities in the single bottle.

The mating surfaces are shown in the embodiments in the drawings as intimately adjacent one another over the entire surface. In alternative embodiments, the mating surface includes depressions or bubbles in the interface between the two shapes, for example to insert or create an artistic feature or even hold an additional element such as a “prize”. The contact between the mating surfaces in these embodiments is limited to a portion of the surface or the perimeter of the surface.

As shown in FIG. 2a-2c and 3a-3c, first bottle half 22 and second bottle half 24 each have two ends, a bottom end 30 and a top end 32. The bottom end is closed and is typically flat or concave, providing a base 46 for standing the bottle 20 upright. The top end of each bottle half has an opening 48 for individually dispensing the contents of each bottle half. While the opening 48 can be any shape, the opening in FIG. 2 is “D” shaped. Top portion 32 may also have a threaded or unthreaded protrusion 50 such as a bottle neck with provisions for receiving a cap or other means of sealing the opening, as will be described in greater detail subsequently.

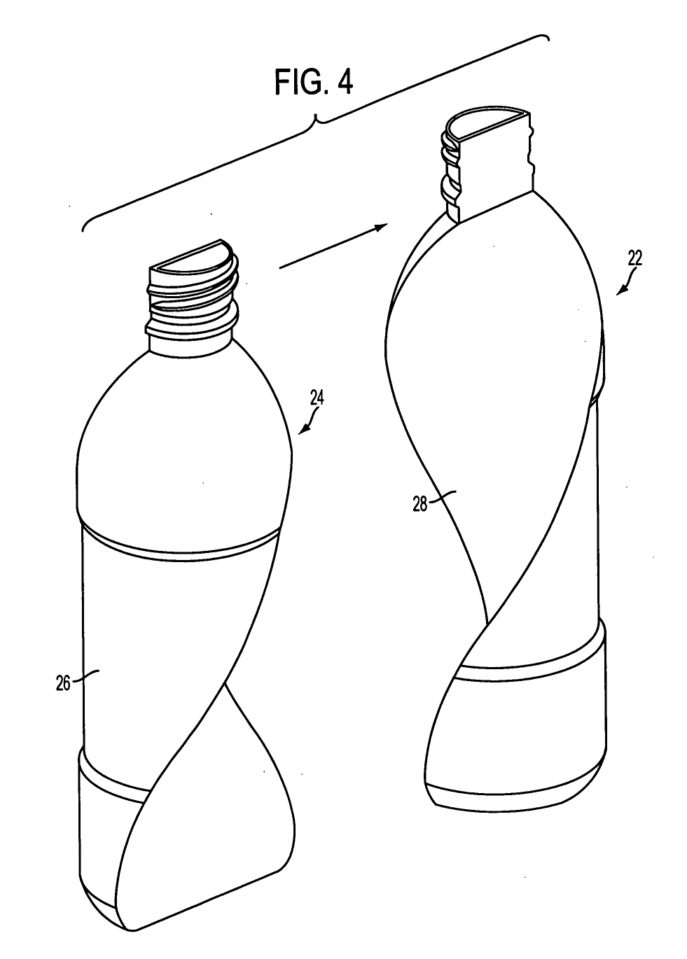

An exploded isometric view of the bottle for the embodiment described is shown in FIG. 4. The combined bottle can incorporate more than two bottle cavities, but the embodiments shown herein for simplicity provide two cavities. The separate cavities of the combined bottle 20 can be used to contain any substance that a person practicing the invention desires. One anticipated embodiment is as a beverage container holding, for example, an electrolyte replacing sports drink in one cavity and water in the second cavity.

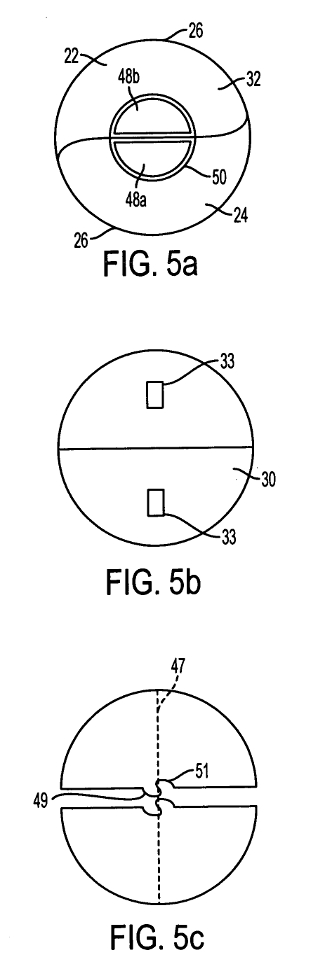

FIG. 5a is a top view and FIG. 5b is a bottom view of the bottle 20 formed by first bottle half 22 and second bottle half 24 being intertwined and seated together as previously described. Since both first bottle half 22 and second bottle half 24 are separate containers, each capable of holding a liquid and keeping the liquid sealed and separate from the contents of the other bottle half, there is a separate opening (48a, 48b) in each cavity. In the embodiment of FIG. 5a, the opening of each cavity is generally “D” shaped and when first bottle half 22 and second bottle half 24 are intertwined together, the combination of opening 48a from first bottle half 22 and opening 48b from second bottle half 24 creates a generally cylindrical threaded or unthreaded protrusion 50. An indexing feature 33 for use in orienting the completed bottle for filling is provided in the bottom surface. A symmetrical indexing feature in each half of the bottle is shown, however, in alternative embodiments, a single indexing feature is employed for unsymmetrical bottles or specific filling requirements.

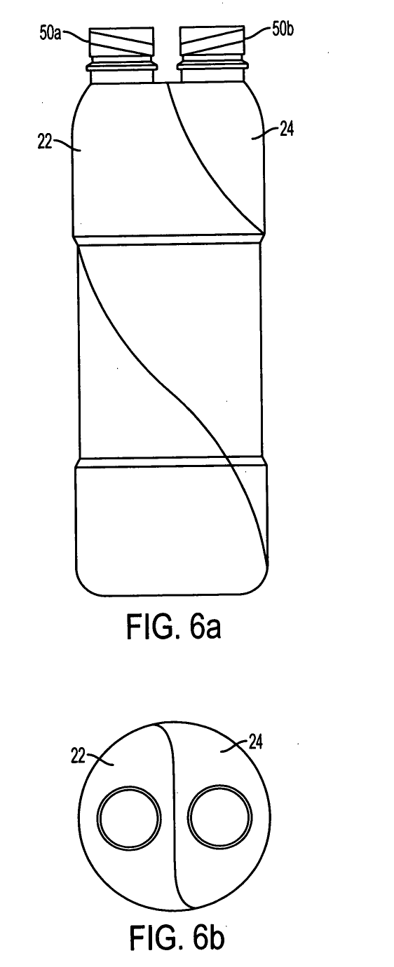

An alternative embodiment is shown in FIGS. 6a and 6b wherein each cavity incorporates a cylindrical bottle neck 50a, 50b which is engaged by either two separate caps or by a single cap capable of receiving two separate cylindrical necks 50a and 50b.

Returning to FIG. 5c, a bottom view of first bottle half 22 and second bottle half 24 is shown with a reciprocal indexing and fastening feature, which is used to assist in indexing the two halves together and securing them in place while a label is installed around the circumference of the bottle 20. A male feature 49 and a female feature 51 are formed along the flat mating surface of the bottle half. Male feature 49 and female feature 51 are formed around the vertical centerline 47 of the bottle half and both features are of the same shape and dimension. This positioning and equal dimensioning allow the features to engage each other as mated moieties when two of the same part bottle half are produced and one is turned to face the other, the male feature 49 and female feature 51 become reciprocally engaged providing the interlocking utility. For the embodiment shown, the male and female features are indented for snap engagement securing the bottle halves together. The male and female features extend the length of the mating surface in certain embodiments while in alternative embodiments, are intermittent or located only proximate the bottom and top of the bottle halves.

FIGS. 2b and 3b are side views of first bottle half 22 and second bottle half 24 in a disassembled state, illustrating the generally cylindrical shape of the outer surface 26 and the generally flat, helically twisted shape of a mating surface 28. Although mating surface 28 may be formed with male or female contour features, bosses or other connecting or indexing features such as dovetails and grooves that may assist in holding first bottle half 22 and second bottle half 24 together, the embodiment shown is a flat helically twisted mating surface 28, allowing the identical molded part to be used as both first bottle half 22 and second bottle half 24. One advantage of this embodiment is that only one mold design is required in order to produce first bottle half 22 and second bottle half 24. Another advantage is simplified assembly and inventory requirements since the bottle halves are identical parts. The addition of male or female contour features, bosses and other connecting or indexing features used on the mating surface 28 of first bottle half 22 and second bottle half 24, as described with respect to FIG. 5c, is accomplished with symmetry to avoid having to manufacture and assemble two different parts (ie. a male bottle half and a female bottle half). The indexing features are designed to be the reciprocal of each other such that when the parts are turned to face each other for assembly, a male feature must engage a corresponding female feature.

The amount of helical twist of mating surface 28, as measured from top end 32 to bottom end 30, can be any number of degrees, but the embodiment described is 180° measuring from top end 32 to bottom end 30. Although any angle of helical twist may be used, one advantage of using an angle of 180° or greater is that the consumer can easily see the contents of both bottle halves from any view point. This is an advantage for a person practicing the invention because it allows for instant consumer recognition of the multiple cavity feature, which differentiates the bottle disclosed herein from other bottles having provisions to contain only one beverage. For example, the ease of recognition and corresponding dual cavity utility is important to a jogger who wants to carry only one bottle that easily fits into their hand but who wants the bottle to contain both a sports beverage and plain water in separate cavities. The consumer in this case can easily determine from any viewing angle that the bottle has such multiple cavities and contains the two beverages they desire. Accordingly, for a helical twist angle of less than 180°, the person practicing the invention may have to carefully position the bottles on the retail shelf in order to ensure that the two halves are clearly visible to the consumer at a given viewing angle. This is because for angles less than 180°, it is possible that the bottle 20 could be positioned such that a consumer could only see one bottle half (because the other bottle half could be hidden from their field of vision) and thus could not readily determine that the bottle 20 actually contains two beverages in separate bottle halves.

A helical rotation of 180° also allows for a relatively simple mold design using techniques known to those skilled in the art. A further advantage is that a helical rotation of 180° helps intertwine and positively couple the bottle halves together. A helical rotation of more than 180° provides for a more positive coupling of the bottle halves, but can create the need for a more complicated and expensive mold, although creating such a mold is possible and known to those skilled in the art of manufacturing molds. A helical rotation of less than 180° may be employed by those practicing the invention, however, both the positive coupling benefit and the ease with which consumers can recognize that the bottle is uniquely comprised of two halves as described above will be progressively compromised as the helical twist angle decreases.

After the bottle halves are coupled together, they are permanently or semi-permanently fastened by a variety of methods. One method is to fasten first bottle half 22 to second bottle half 24 by attaching a cap 36 that screws or snaps over the protrusion 50 of both halves, which then holds the two top portions 30 together. This and other methods of fastening the bottle halves together are described subsequently.

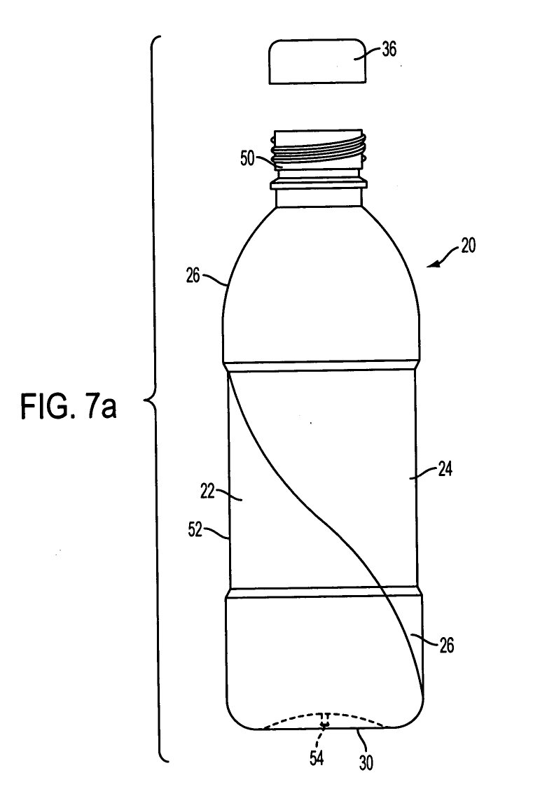

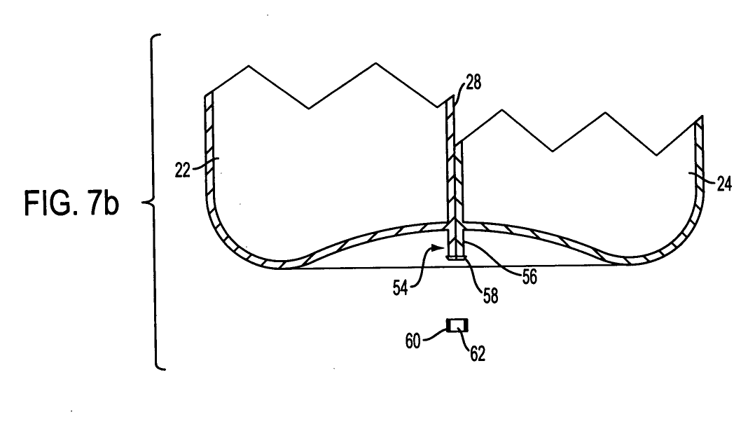

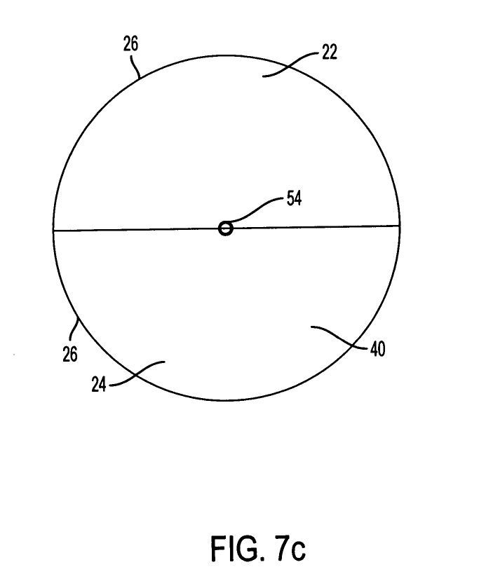

FIG. 7a is a side view of a bottle 20 employing the present invention with two individually sealable bottle halves each having an outer surface 26 with a recessed area 52 for locating a label that circumferentially surrounds the combined bottle 20. In the embodiment in FIG. 7a, the protrusion 50 is threaded, allowing a cap 36 to be affixed to bottle 20, which serves the purpose of sealing the bottle's contents and also of holding first bottle half 22 and second bottle half 24 together. For the embodiment shown in FIGS. 1 and 7a, the thread is a double start thread allowing symmetrical placement of thread starts and partlines between the two bottle halves. In an alternate embodiment, the threads of protrusion 50 are eliminated and cap 36 is attached to the dual bottle with a snap feature on protrusion 50 rather than by a threaded feature. The bottle halves are further fastened together by a web or label, which is wrapped around the circumference of the combined bottle 20 in the location provided by recessed area 52. These methods of fastening the bottle halves together have the advantage of requiring no additional parts or manufacturing process requirements because a bottle cap 36 and a label are generally included on bottles to close the bottle opening, and inform users of the contents therein, respectively. The label is affixed by adhesive to the outer surface 26 of first bottle half 22 and second bottle half 24 in embodiments without recessed area 52.

In alternative embodiments, fastening first bottle half 22 to second bottle half 24 is accomplished by applying a quantity of adhesive or glue on the mating surfaces 28 prior to assembly of the bottle halves.

In another alternative embodiment, a connecting boss 54 (shown with more particularity in FIG. 7b) formed in the center of the bottom end 30 of first bottle half 22 and second bottle half 24. For the embodiment shown in the drawings, the connecting boss 54 is generally half-cylindrical or “D” shaped with a flat side located co-planar to mating surface 28. When first bottle half 22 and second bottle half 24 are intertwined and seated together, the connecting boss 54 of first bottle half 22 and the connecting boss 54 of second bottle half 24 are located together so as to form a generally cylindrical protrusion for permanently fastening first bottle half 22 and second bottle half 24 together.

FIG. 7b is a partial section view taken through first bottle half 22 and second bottle half 24 in an assembled state. The connecting boss 54 of first bottle half 22 and the connecting boss 54 of second bottle half 24 are co-located so that they form a generally cylindrical protrusion having a post 56 and optional flared barb 58. A generally cylindrical collar 60 is snapped into position with the inner diameter of collar 60 engaging post 56 for the purpose of fastening first bottle half 22 and second bottle half 24 together from the bottom. The outer face 62 of collar 60 is engaged by flared barb 58 to prevent removal of collar 60 and the subsequent separation of first bottle half 22 and second bottle half 24. In alternative embodiments, collar 60 is eliminated and post 56 is formed without the flared barb and “heat-staked” to melt the plastic of post 56 on first bottle half 22 and the plastic of post 56 on second bottle half 24 so that when the plastic cools, first bottle half 22 and second bottle half 24 are permanently joined together. “Heat-staking” and other plastic joining methods such as gluing and ultrasonic welding are well-known to those skilled in the art.

FIG. 7c is a bottom view of the combined bottle formed by first bottle half 22 and second bottle half 24 being intertwined in an assembled state. This view illustrates the connecting boss 54 of first bottle half 22 and the connecting boss of second bottle half 24 forming a generally cylindrical protrusion for receiving collar 60 to permanently fasten first bottle half 22 to second bottle half 24.

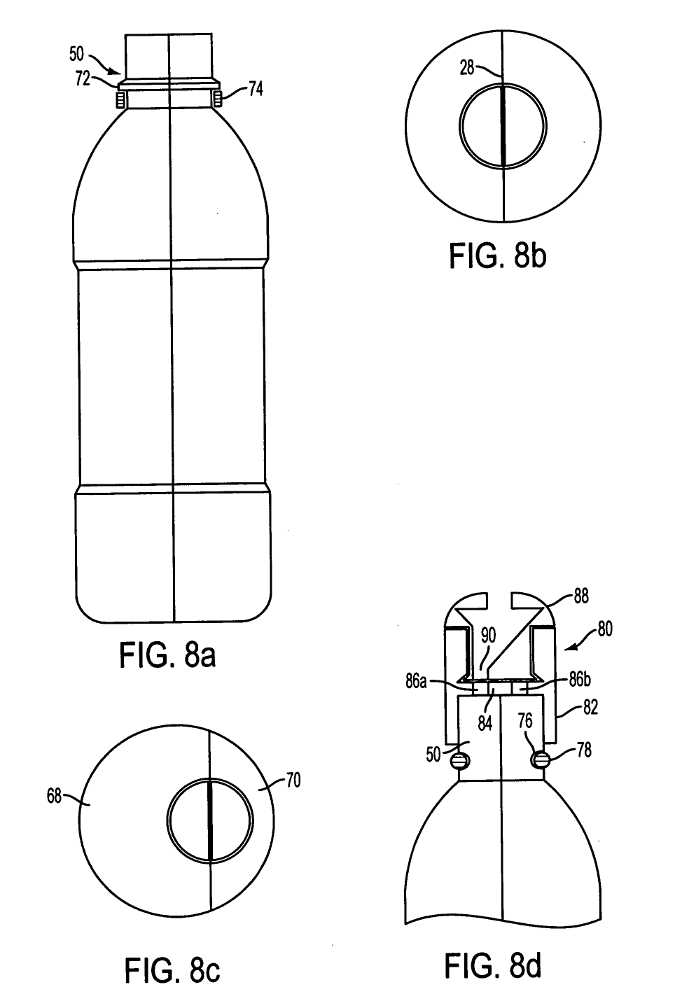

FIGS. 8a through 8d demonstrate alternative connection and cavity configurations for various embodiments of the present invention. FIGS. 8a and 8b show a combined bottle incorporating two individually sealable bottle halves with a flat, non-helical mating surface 28 joined by one or more of the methods identified previously in this description. The two cavities need not be constructed as equally proportioned halves, they may be constructed in unequal halves as shown by large left half 68 and small right half 70 demonstrated in FIG. 8c. For additional strength in securing the bottle halves, the embodiment of FIG. 8a incorporates a flange 72 over which a collar 74 (shown in section) is forced to circumferentially engage the protrusion 50. An alternative embodiment of an upper engagement is shown in FIG. 8d wherein an indentation 76 is provided in the circumference of protrusion 50 in which a ring 78 (shown in section) is engaged. Either of these embodiments in combination with a bottom connection as previously described with respect to FIG. 5c or 7b securely connects the bottle halves at both the top and bottom allowing assembly of the complete bottle prior to filling and labeling.

FIG. 8d additionally shows an alternative cap mechanism 80. A substantially cylindrical housing 82 is received over the protrusions 50 of the bottle halves. A web 84 seals the housing with apertures 86a and 86b positioned over the openings 48a and 48b in the respective bottle halves. A rotatable plug 88 is received in the housing and incorporates a channel 90 which is positionable over aperture 86a for communication with the cavity of the first bottle half or over aperture 86b for communication with the cavity of the second bottle half or intermediate the two apertures to re-seal the bottle. In alternative embodiments, the housing incorporates a circumferential protrusion which mates with indentation 76 to eliminate the requirement for a separate securing ring. As with joining of the bottle elements, the housing is adhesively bonded to the protrusions in alternative embodiments.

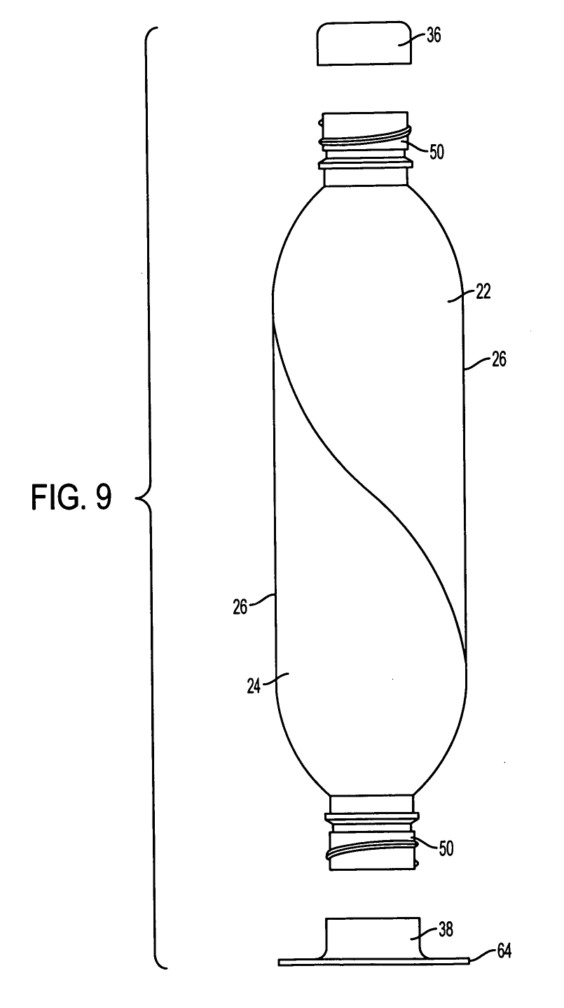

FIG. 9 is a side view of a combined bottle comprised of two individually sealable bottle halves, each having a protrusion 50 at opposite ends of the combined bottle for receiving a cap 36 or a bottom cap 38 to seal the beverage contained therein. Bottom cap 38 is formed with a larger outer diameter flange 64, which provides stability for standing the bottle upright. The flange 64 may have an outer diameter of any dimension or proportion, but the embodiment of FIG. 8 is for the outer diameter of the flange 64 to generally match the outer diameter of the combined bottle as defined by outer surface 26.

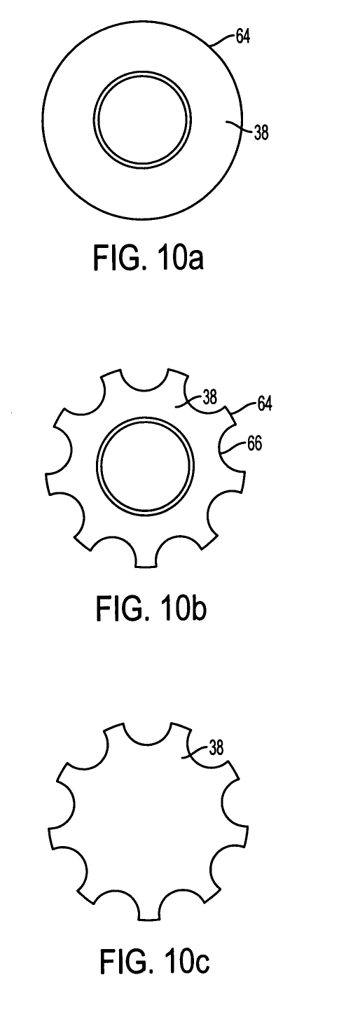

FIG. 10a through 10c show several views of bottom cap 38 in two embodiments. One embodiment provides flange 64 being formed in a generally round shape. Another embodiment provides flange 64 with a plurality of inward undulations 66 that are usable by the consumer to grip the bottom cap 38 while fastening or unfastening it from the bottle while still providing the same stability as the round flange due to its equal outside dimension. There are many other shapes that flange 64 could be constructed from by those practicing the invention.

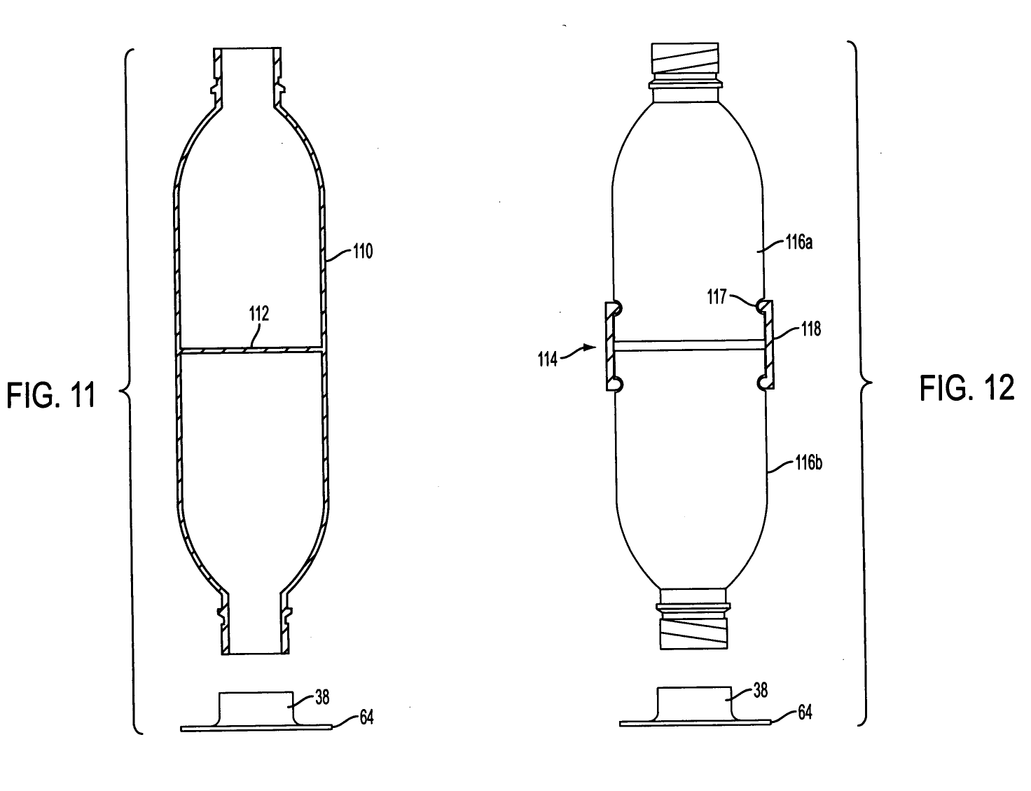

FIGS. 11 and 12 are section views of a bottle similar to that bottle shown in FIG. 9, except that FIG. 11 is a dual neck bottle formed as a single part and FIG. 12 is a dual neck bottle formed as two identical parts.

FIG. 11 shows a bottle 110 formed with a horizontal septum 112, which is held upright with a cap 38 having an oversized flange 64 as shown and described in more detail in FIG. 9 and FIG. 10 previously. Bottle 110 is formed as one part, having two separate cavities. Bottle 114 of FIG. 12 is a dual cavity bottle made up of two separate elements 116a and 116b with the adjoining mating surface substantially perpendicular to the outer surface, each having a screw thread or circumferential groove 117 allowing a collar 118 to snap or screw the two bottles together. In one embodiment, the separate bottles are identical in size and shape but may contain different contents such as beverages. This invention allows a multitude of various beverages to be sold in such single bottles and a consumer may later chose, at their discretion, two desirable beverages and may then connect them into one bottle by means of collar 118, which may be supplied along with bottles that are sold to consumers. In one embodiment, the collar 118 is formed from plastic.

First bottle half 22 and second bottle half 24 may be formed by a number of manufacturing techniques with one embodiment being blow molded from a plastic material. Alternately, the bottle halves may be formed from glass or aluminum by methods known to those skilled in the art of manufacturing glass or aluminum beverage bottles. The state of the art plastic materials used to produce beverage bottles today are polyethylene terephthalate (“PET” or “PETE”), and high density polyethylene (“HDPE”).

In exemplary embodiments, first bottle half 22 and second bottle half 24 are formed from polyethylene terephthalate (“PET” or “PETE”). Alternately, first bottle half 22 and second bottle half 24 may be formed from different materials from each other or from different colors from each other in order to highlight to consumers that the combined beverage container is comprised of two bottle halves.

One method of manufacture for the bottle halves is to injection mold a preform of the bottle as a first manufacturing step and then reheat and blow mold the preform in a stretch blow molding machine as a second manufacturing step. This process is known to those skilled in the art of manufacturing high volume beverage bottles from plastic materials. Another way to manufacture the bottle halves is by single step blow molding techniques known to those skilled in the art such as extrusion blow molding.

An exemplary process for the two piece helical body embodiments described previously employs a preform having a “D” shaped neck with dual start threads embossed on the half cylinder but not the flat inner surface and a substantially “D” shaped preform element depending from the neck for expansion. The preform is loaded into a blow molding machine with the neck restrained and the depending portion of the preform body is reheated. A mold with a cavity having a helical wall is employed with the flat surface of the preform parallel with the start of the helical wall A stretch rod having a helical shape is inserted through the neck to urge the softened plastic of the preform down to the bottom of the mold cavity using partial expansion pressure prior to full internal pressure being applied to form the bottle. The helical shape of the stretch rod causes the rod to spiral down into the mold in a shape and dimension that requires the rod to track down the length of the helical mold cavity maintaining an equal distance from the surface of the mold and prevents contact of the rod with the walls of the helically shaped mold. Upon completion of the rod insertion, full pressure is applied to the preform to complete the expansion into the walls of the mold cavity. The mold is a two part mold creating a cavity with the final shape of the symmetrical element of one half of the assembled bottle as described above. Separating the mold allows removal of the completed bottle half.

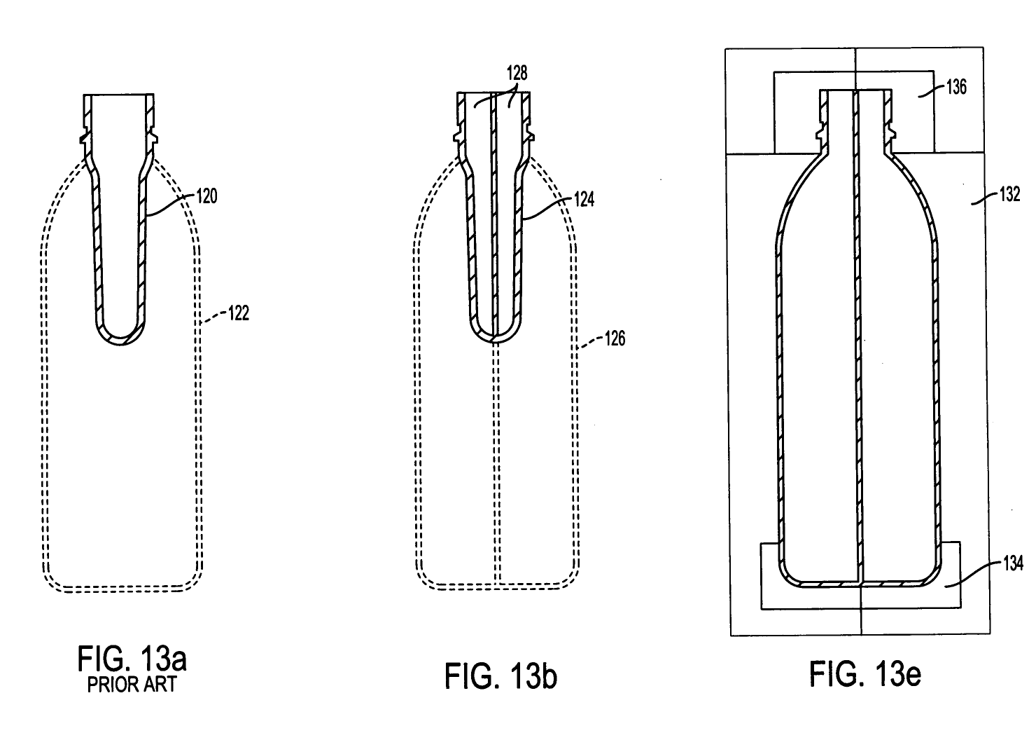

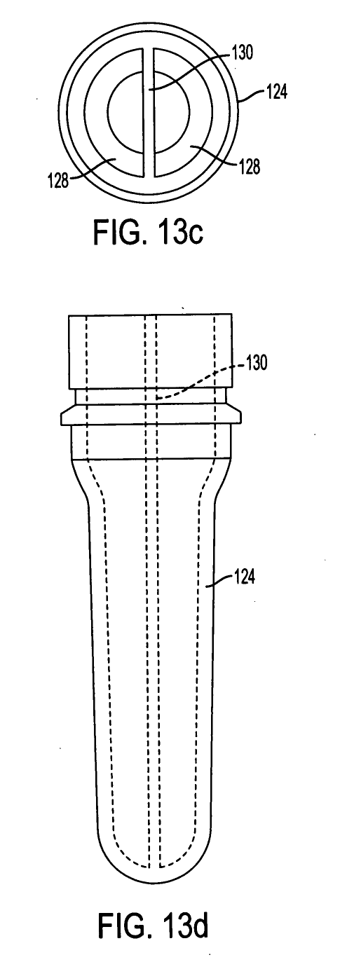

In an alternative embodiment to the two element bottle process described previously, FIG. 13a shows a prior art example of a single cavity perform 120 for creating a bottle of the present invention as a single piece. The stretch blow molded final bottle 122 (shown in phantom).

FIG. 13b shows the alternate embodiment preform for the dual cavity bottle of the present invention to be manufactured as a single bottle rather than in two separate cavities such as first bottle half 22 and second bottle half 24 as described above. The first manufacturing step in the single part embodiment is for the bottle to be injection molded as a preform 124 prior to being blow molded into the final shapes 126. The practice of injection molding preforms and then blow molding final bottle shapes is known to those skilled in the art of manufacturing blow molded bottles. The preform 124 along with the corresponding final bottle shape 126 are an embodiment of the present invention, which is an improvement over the current state of the art because the resulting dual cavity bottle 126 is formed easily and with similar manufacturing steps, but has additional utility to the end user of the bottle. To manufacture a dual cavity bottle in a single part, the preform 124 is injection molded with two generally “D”-shaped cavities 128 and an inner septum 130 to separate the cavities 128 (shown with more particularity in FIGS. 13c and 13d). A next step is to load the preform 124 into a blow molding machine, which then reheats the plastic, by infrared radiation or other means, to a softer state and, among other steps, mechanically forces the bottom of the preform towards the bottom of the mold, and applies a quantity of air pressure to the inside of the cavities 128 of the preform 124. This air pressure forces the softened plastic to expand until contact is made with the inner shape of a mold 132 as shown in FIG. 13e. The final shape will have dual cavities that comprise a single part bottle with an inner septum. The single part bottle may be manufactured such that the inner septum 130 is formed as a flat plane, or as a flat plane with a helical twist. In one embodiment, the helical twist of inner septum is 180°. The helical twist of inner septum 130 is obtained by loading preform 124 into a mold 132, heating the plastic to the desired softened state, applying air pressure to the cavities 128, and then rotating a bottom portion of the mold 134 relative to a fixed top portion 136 that restrains the bottle neck. The plastic is allowed to cool in the rotated state and the final bottle is ejected from the mold. FIG. 13e shows the mold in section with the bottle expanded but not yet rotated. The resulting single part bottle, as described above, has two independent cavities 128 separated by an inner septum 130, which is an integral part of the bottle.

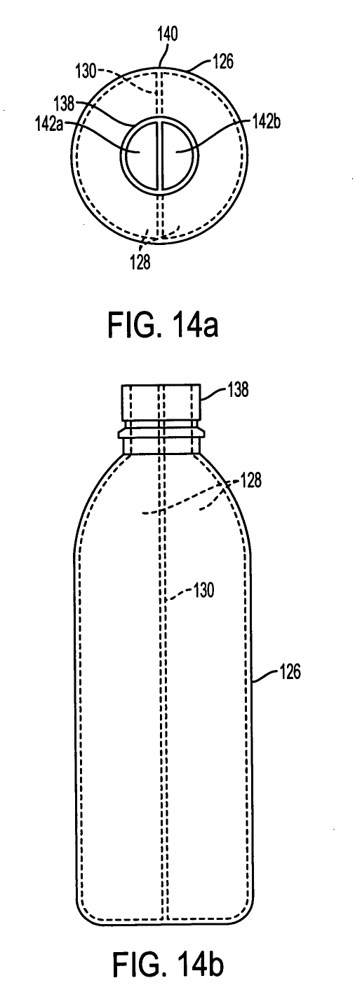

FIG. 14a shows a top view and FIG. 14b a front view of the single part bottle from FIG. 13 that is formed from preform 124. The two cavities 128 are shown in hidden view by dashed lines. The inner septum 130 is visible at the top surface of a generally cylindrical neck 138 that is formed at the top of the bottle for receiving a bottle closing device such as a cap. The inner septum 130 is also shown in hidden view with dashed lines to illustrate how it separates the two cavities 128 and blends into the outer wall of the bottle at a joint 140. The inner septum forms two, generally “D”-shaped openings 142a and 142b at the top of the neck. A person practicing this invention in the exemplary embodiment will fill each of the two cavities through its respective opening. The inner septum separates the two cavities from each other such that two different objects, such as beverages, could be contained therein and would be sealably separated from each other as there is no means of fluid communication between the cavities.

Having now described the invention in detail as required by the patent statutes, those skilled in the art will recognize modifications and substitutions to the specific embodiments disclosed herein. Such modifications are within the scope and intent of the present invention as defined in the following claims.

1. A multiple cavity bottle comprising:
a first element with a first cavity having a mating surface and an outer surface;
a second element with a second cavity having a mating surface and an outer surface, the second element geometrically identical and symmetrical to the first element, the mating surface of the second element complimentary in shape to the mating surface of the first element and the second element engaging the first element with contact of the mating surface of the first element and the mating surface of the second element; and,
means for interconnecting the first element and second element.

2. A multiple cavity bottle as defined in claim 1 wherein the mating surface of the first element and the mating surface of the second element are helical.

3. A multiple cavity bottle as defined in claim 2 wherein the helical mating surfaces are substantially planar in cross-section.

4. A multiple cavity bottle as defined in claim 1 wherein the interconnecting means comprises:
a male feature present on the mating surface of the first element and
a female feature present on the mating surface of the second element positioned to engage the male feature;
a second female feature symmetrical to the male feature present on the mating surface of the first element and a second male feature symmetrical to the female feature present on the mating surface of the second element to render the first and second elements geometrically identical, the symmetrical second male feature and symmetrical second female feature further interlocking the first and second element.

5. A multiple cavity bottle comprising:
a first element with a first cavity having a mating surface and an outer surface;
a second element with a second cavity having a mating surface and an outer surface, the mating surface of the second element complimentary in shape to the mating surface of the first element and the second element engaging the first element with contact of the mating surface of the first element and the mating surface of the second element;
a connecting boss extending from a bottom surface of the first element;
a connecting boss extending from a bottom surface of the second element; and,
means for engaging the first element connecting boss and the second element connecting boss.

6. A multiple cavity bottle as defined in claim 5 wherein the first and second element connecting bosses are substantially half-cylindrical with a flat surface coplanar with the mating surface and positioned on an axis of symmetry, and the engaging means comprises a collar received over the connecting bosses.

7. A multiple cavity bottle as defined in claim 6 wherein the connecting bosses further incorporate a flare on each connecting boss distal the bottom surface for retaining engagement of the collar.

8. A multiple cavity bottle as defined in claim 5 wherein the engaging means comprises a heat stake fusing the connecting bosses.

9. A multiple cavity bottle as defined in claim 1 further comprising a protrusion extending from a top portion of each of the first element and second element and having an opening in communication with the cavity therein.

10. A multiple cavity bottle as defined in claim 9 wherein each protrusion is located on an axis of symmetry.

11. A multiple cavity bottle as defined in claim 10 wherein each protrusion is substantially half cylindrical with a flat surface, the flat surface of the protrusion on the first element engaging the flat surface of the protrusion on the second element.

12. A multiple cavity bottle as defined in claim 11 wherein the interconnecting means comprises a ring received over the engaged protrusions.

13. A multiple cavity bottle as defined in claim 11 further comprising threads on each half cylindrical protrusion and the interconnecting means comprises a cap threadably engaging the protrusions.

14. A multiple cavity bottle as defined in claim 1 wherein the interconnecting means comprises a label encircling the outer surface of the first and second element.

15. A multiple cavity bottle as defined in claim 14 wherein each outer surface incorporates an indentation to receive the label.

16. A multiple cavity bottle as defined in claim 1 wherein the first element and second element each incorporate a protrusion having an opening in communication with the cavity, the protrusion on the first element oriented substantially opposite to the protrusion on the second element with the mating surfaces of the elements engaged in intimate contact and further comprising a cap for each protrusion, one of said caps having an extended flat surface perpendicular to and distal from an opening to receive the protrusion.

17. A multiple cavity bottle as defined in claim 16 wherein the mating surface of the first element and the mating surface of the second element are helical.

18. A multiple cavity bottle as defined in claim 17 wherein the helical mating surfaces are substantially planar in cross-section.

19. A multiple cavity bottle as defined in claim 16 wherein the mating surface of each element is substantially perpendicular to the outer surface and wherein the outer surface of each element incorporates a groove proximate the mating surface, and the interconnecting means comprises a collar received over the outer surface of each element and engaging the grove in each element with the mating surfaces engaged.

20. A multiple cavity bottle comprising:
a first element with a first cavity having a mating surface and an outer surface;
a second element with a second cavity having a mating surface and an outer surface, the mating surface of the second element complimentary in shape to the mating surface of the first element and the second element engaging the first element with contact of the mating surface of the first element and the mating surface of the second element;
a protrusion extending from a top portion of each of the first element and second element and having an opening in communication with the cavity therein, each protrusion is located on an axis of symmetry and substantially half cylindrical with a flat surface, the flat surface of the protrusion on the first element engaging the flat surface of the protrusion on the second element; and,
means for interlocking the protrusions.

21. A multiple cavity bottle as defined in claim 20 wherein the interlocking means comprises a ring received over the engaged protrusions

22. A multiple cavity bottle as defined in claim 20 wherein the interlocking means includes a substantially cylindrical housing received over the engaged protrusions, the housing having a web with a first aperture positioned over the opening in a first one of the protrusions and a second aperture positioned over the opening in a second one of the protrusions;
a rotatable plug received in the housing adjacent the web and incorporating a channel selectively positionable over the first aperture for communication with the cavity of the first bottle half and over the second aperture for communication with the cavity of the second bottle half and intermediate the two apertures to seal both cavities.

23. A multiple cavity bottle comprising:
a first portion with a first cavity having an outer surface;
a second portion with a second cavity having an outer surface, the first and second portions connected by a mating septum.

24. A multiple cavity bottle as defined in claim 23 wherein the mating septum is helical.

25. A multiple cavity bottle as defined in claim 23 wherein the first portion and second portion each incorporate a protrusion having an opening in communication with the cavity, the protrusion on the first portion oriented substantially opposite to the protrusion on the second portion each protrusion distal from the mating septum, and further comprising a cap for each protrusion, one of said caps having an extended flat surface perpendicular to and distal from an opening to receive the protrusion.

26. A multiple cavity bottle as defined in claim 23 wherein the first portion and second portion each incorporate a protrusion having an opening in communication with the cavity, the protrusion on the first portion and the protrusion on the second portion oriented in a common direction and separated by a plane extending from the septum.

27. A method for manufacturing a multiple cavity bottle comprising the steps of:
providing a preform having a first portion with a first cavity having an outer surface and a second portion with a second cavity having an outer surface, the first and second portions connected by a mating septum;
expanding the preform into a stretch blow mold.

28. A method for manufacturing a multiple cavity bottle as defined in claim 27 wherein the step of providing a preform comprises injection molding a preform having two substantially half cylindrical cavities separated by a septum.

29. A method for manufacturing a multiple cavity bottle as defined in claim 27 further comprising the step of rotating a bottom portion of the stretch blow mold to helically shape the mating septum.

30. A method for manufacturing a multiple cavity bottle comprising the steps of:
injection molding a preform having two substantially half cylindrical cavities separated by a septum;
expanding the preform into a stretch blow mold having a fixed portion engaging a neck of the preform and a rotatable portion receiving a base of the expanded bottle; and,
rotating the rotatable portion of the mold to helically shape the mating septum.

31. A method for manufacturing a multiple cavity bottle comprising the steps of:
providing a mold with at least one substantially helical inner surface;
providing a preform with one flat surface;
engaging the preform in the mold with the flat surface aligned with an initiation of the helical inner surface;
reheating an expandable portion of the preform;
inserting a helically shaped stretch rod into the preform with partial pressurization to spirally stretch the preform;
fully pressurizing the preform into the mold to create a bottle element;
assembling the bottle element with a second bottle element to create a dual cavity bottle.

32. A method for manufacturing a multiple cavity bottle as defined in claim 31 wherein the mold is a multiple part mold and further comprising the step of splitting the mold for removal of the expanded bottle element.

33. A method for manufacturing a multiple cavity bottle as defined in claim 31 wherein the step of providing a preform comprises the step of injection molding a preform having a substantially “D” shaped neck portion and a depending substantially “D” shaped expansion portion and wherein the step of engaging the preform in the mold comprises the step of engaging the neck portion of the preform in the mold.

34. A method for manufacturing a multiple cavity bottle as defined in claim 31 wherein the bottle element created is substantially symmetrical and the bottle element and second bottle element are created from the same mold.
